(19) United States
(12) Patent Application Publication
(10) Pub. No.: US 2016/0319881 A1
(43) Pub. Date: Nov. 3, 2016

(54) SYSTEM FOR COUPLING A DRIVING MACHINE WITH A DRIVEN MACHINE

(71) Applicant: MOTEURS LEROY-SOMER, Angouleme (FR)

(72) Inventor: Patrick VOHLGEMUTH, LA ROCHEFOUCAULD (FR)

(73) Assignee: MOTEURS LEROY-SOMER, Angouleme (FR)

(21) Appl. No.: 15/105,171

(22) PCT Filed: Dec. 9, 2014
(86) PCT No.: PCT/IB2014/066724

§ 371 Date: Jun. 16, 2016

(30) Foreign Application Priority Data
Dec. 16, 2013 (FR) 1362714

(51) Int. Cl. F16D 1/104; H02K 7/18; H02K 15/16; F16D 1/112

(52) U.S. Cl. CPC F16D 1/104; F16D 1/112; H02K 7/1815; H02K 15/16; H02K 2207/00; H02K 2213/12

(57) ABSTRACT

The present invention concerns a system for coupling a driving machine with a driven machine comprising a driving machine disk comprising first reliefs, and a driven machine disk comprising second reliefs. The second reliefs are arranged relative to the first reliefs to enable the coupling system to form a first configuration allowing axial separation according to the axis of rotation of the two discs and in which the two disks are in contact, the first reliefs being angularly offset relative to the second reliefs, and a second configuration in which the second reliefs engage with the first reliefs and oppose the axial movement of the two disks relative to each other. The shift from the first to the second configuration is made by a rotation of the two disks relative to each other about the axis of rotation.

The present invention concerns a system for coupling a driving machine, in particular a thermal engine, with a driven machine, in particular an alternator.

Some driven machines, in particular single-bearing alternators, are designed such that the extremity of the rotor rests on the crankshaft bearing of the driving machine. The interface between the rotor and the crankshaft is usually provided by coupling disks, in particular metal coupling disks, that are centered and fixed on the flywheel of the driving machine to enable torque transmission and misalignment compensation. The stator of the alternator is usually attached using a connecting flange to the housing of the driving machine. The connection and centering of the driven machine with the driving machine are ensured using openings arranged around the periphery of the connecting flange. SAE standards J617 and J620 require that the face of the disk used for attachment to a centering on the flywheel be axially offset towards the inside of the housing of the engine. This makes connection and centering operations complicated, in particular due to the low visibility and difficult access to this disk.

The invention is intended to facilitate the connection of a driven machine and of a driving machine.

### SUMMARY

The invention is intended to address this objective and it does so using a system for coupling a driving machine, in particular a thermal engine, with a driven machine, in particular an alternator, comprising:
a driving machine disk that is designed to be centered on and attached to same along an axis of rotation and that includes first reliefs distributed angularly about the axis of rotation, and
a driven machine disk that is arranged to be centered on and attached to same along the axis of rotation and that includes second reliefs distributed angularly about the axis of rotation,

the second reliefs being arranged in relation to the first reliefs such as to enable the coupling system to adopt:
a first arrangement enabling an axial separation along the axis of rotation of the two disks of the driving and driven machines and in which the two disks are in contact, the first reliefs being angularly offset in relation to the second reliefs, and
a second arrangement for transmitting torque, in which the second reliefs engage with the first reliefs and oppose the axial movement of the two disks relative to one another,

the shift from the first to the second arrangement being made by a reciprocal rotation of the two disks about the axis of rotation.

The invention enables a disk to be easily attached to each machine before assembly of same. The disks are connected by positioning in a first arrangement then starting the driving machine. This causes the rotation of the driving machine disk that is engaged by the first reliefs with the second reliefs of the driven machine disk. The two disks are attached to one another and the driving machine disk turns the driven machine disk by transmitting the torque of the driving machine to same.

Preferably, the driving machine is an engine, in particular a thermal engine, and the driven machine is an alternator.

Also preferably, the driving machine turns counterclockwise. The rotation of the driving machine disk in relation to the driven machine disk to switch from the first to the second arrangement is therefore counterclockwise.

The driven machine disk is preferably attached to the rotor, in particular the shaft of the rotor, of the driven machine using attachment elements, in particular screws, via holes made in the internal portion of the disk.

The driving machine disk is preferably attached to the flywheel of the driving machine using attachment elements, in particular screws, via holes made in the peripheral portion of the disk.

The disks are preferably made of metal, in particular steel.

The two disks may each have an opening to receive and center the shaft of the driven machine.

The diameter of the disk intended for the driving machine is preferably greater than the diameter of the disk intended for the driven machine. This helps to attach the disks to the driving and driven machines.

At least one of the two disks may have a centering relief to align the two disks on the axis of rotation when they are moved towards one another.

In particular, the two disks may each have centering reliefs, the centering reliefs taking the form, on one of the disks and as seen from the front, of at least one recess and on the other disk, as seen from the front, of at least one projection that fits into the recess.

“Seen from the front” means that the user is viewing the disk from the front, on the side opposite the side of the corresponding machine.

The first and second reliefs are preferably equally distributed angularly about the axis of rotation. The number of first reliefs and the number of second reliefs are preferably between 2 and 20, and ideally between 4 and 12.

In the first arrangement, preferably, the first reliefs and the second reliefs are not superposed on one another. The angular separation between the first and second reliefs is sufficient to prevent same from overlapping. In the second arrangement, the first reliefs are preferably at least partially superposed on the second reliefs, when the disks are observed along the axis of rotation of same.

The first reliefs are preferably obtained by cutting and/or stamping the driving machine disk. The same is true for the second reliefs.

The first reliefs may take the form of hooks projecting from the side of the disk opposite the driving machine.

These hooks may be oriented radially inwards or orthoradially. “Oriented radially inwards” means that the hooks are oriented towards the axis of rotation. “Oriented orthoradially” means that the hooks are each oriented along an axis perpendicular to the radius of the disk, in the same direction as the circumference.

Preferably, if they are oriented radially, the hooks are open at one of the circumferential extremities of same and closed at the opposing extremity.

The second reliefs may take the form of teeth extending radially outwards, in particular if the first reliefs are radially oriented hooks. The extremities of the teeth are preferably curved towards the side opposite the driven machine side. Preferably, when the driving machine disk is rotating in relation to the driven machine disk, each tooth engages in the opening of the corresponding first relief to engage with this latter.

In a variant, the second reliefs may take the form of hooks projecting from the side of the disk opposite the driven machine.

These hooks are preferably oriented orthoradially, in particular where the first reliefs are also oriented orthoradially. Preferably, the hooks are oriented circumferentially in the same direction as the first reliefs, when viewed from the front, to enable same to engage with the first reliefs by reciprocal rotation of the two disks.

The first and/or second reliefs preferably have locking reliefs tending to oppose reciprocal rotation of the disks in the uncoupling direction of the first and second reliefs. The locking relief or reliefs may have slots or notches. In a variant, the locking relief or reliefs on either the first or second relief each include a tab. The other disk has one or more seats each designed to receive a tab.

The tab is preferably formed by a cutout of the relief that engages when the two disks are assembled, in the cutout defining the seat formed by the other of the first and second reliefs, to lock against the edge of the cutout.

Preferably, the first and second reliefs each have a body having one face that is designed to come into contact with a face of the body of the other corresponding relief. This face may have an increasing incline around the circumference forming an angle of between 2° and 10° with the midplane of the corresponding disk. Acting as a wedge, this incline makes it possible to achieve a join between the corresponding first and second reliefs with no play, in the second arrangement of the coupling system.

The invention also relates to an electricity generator comprising:
an engine, in particular a thermal engine,
an alternator including a rotor driven in rotation by the engine,
a system for coupling the engine with the alternator as described above, transmitting torque between the engine and the alternator, the driving machine disk being attached to the engine, in particular to a flywheel of the engine, and the driven machine disk being attached to the rotor of the alternator.

The invention also relates to a method for assembling an electricity generator comprising the following steps:
attaching the driving machine disk according to the invention to a flywheel of the engine,
attaching the driven machine disk according to the invention to the rotor of the alternator,
moving the two disks towards one another axially to create the first arrangement of the coupling system according to the invention, and
starting the engine so that the second reliefs engage, by reciprocal rotation of the two disks, with the first reliefs in the second arrangement of the coupling system.

The two disks are attached to the driving and driven machines before assembly of the engine and the alternator.

The invention is further explained in the detailed description given below of nonlimiting example embodiments of the invention and the attached drawings, in which:

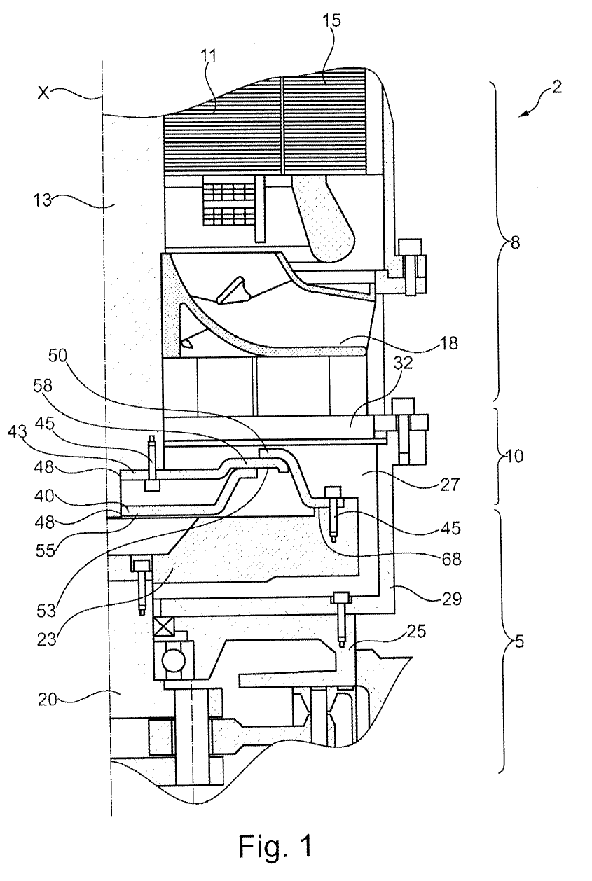

FIG. 1 is a schematic partial cross section of an electricity generator according to the invention,

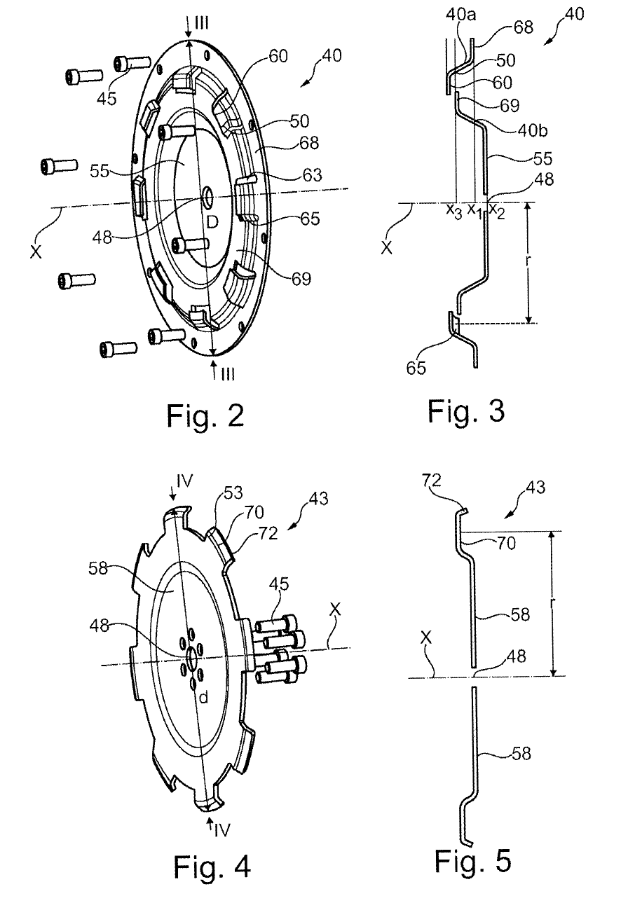

FIG. 2 is a perspective view of an example of the driving machine disk according to the invention,

FIG. 3 is a cross-sectional view of the disk in FIG. 2,

FIG. 4 is a perspective view of a driven machine disk according to the invention,

FIG. 5 is a cross-sectional view of the disk in FIG. 4,

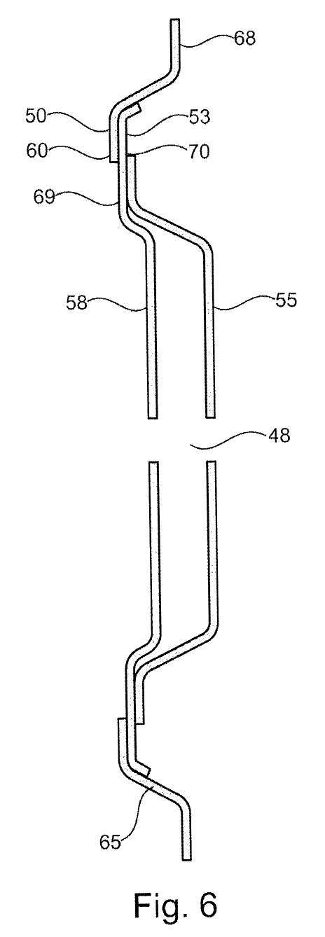

FIG. 6 is a cross-sectional view of a coupling system according to the invention,

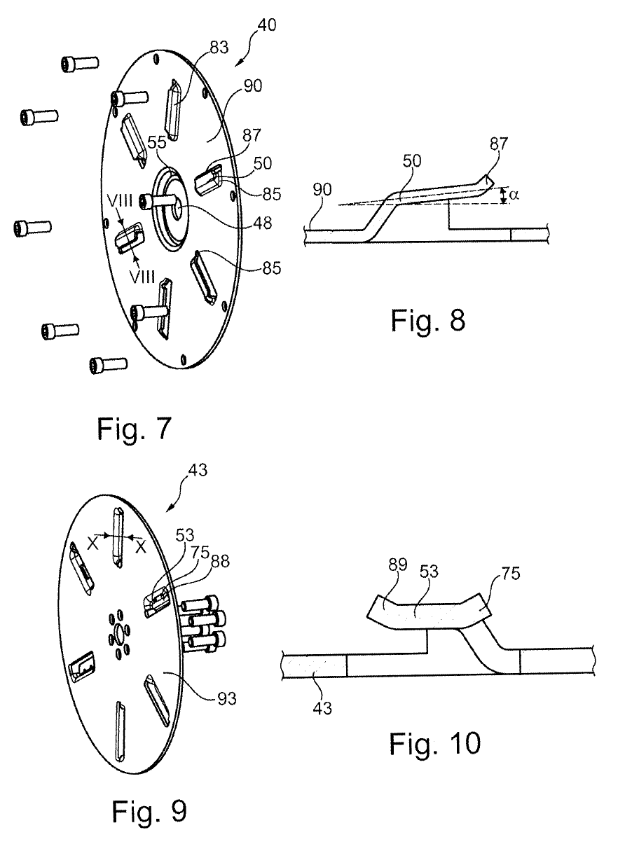

FIG. 7 is a perspective view of a variant driving machine disk,

FIG. 8 is a partial cross-sectional view taken along VIII-VIII in FIG. 7,

FIG. 9 is a perspective view of a variant driven machine disk,

FIG. 10 is a partial cross-sectional view along X-X in FIG. 9,

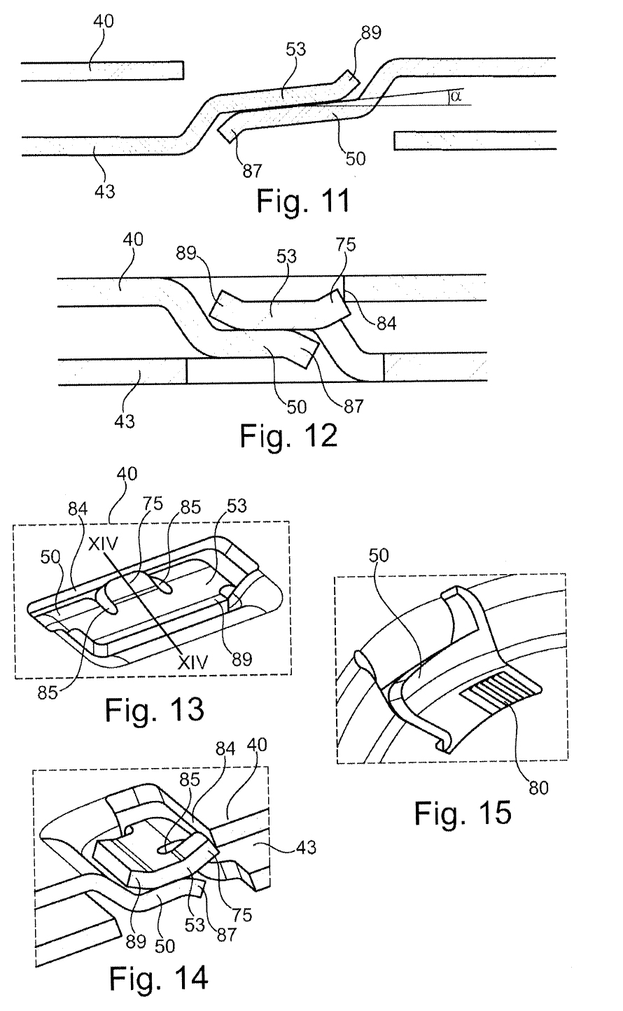

FIG. 11 is a cross-sectional view of a detail of a coupling system taken along an orthoradial plane of the disks,

FIG. 12 is a view similar to the view in FIG. 11 of a variant embodiment,

FIG. 13 is a perspective view of the assembly in FIG. 12,

FIG. 14 is a cross-sectional view taken along XIV-XIV of the assembly in FIG. 12, and

FIG. 15 is a partial perspective view of an example of the disk relief according to the invention.

The electricity generator 2 according to the invention, shown partially in FIG. 1, includes a driving machine 5, in particular a thermal engine, and a driven machine 8, in particular an alternator, caused to rotate by the driving machine 5. The driving machine 5 and the driven machine 8 are connected by a coupling system 10 that ensures the transmission of torque from the driving machine to the driven machine.

The driving machine 5 comprises, for example and as illustrated, a crankshaft 20 driven in rotation when the driving machine 5 is in operation, to which a flywheel 23 is rigidly attached, said flywheel being moveable in relation to the housing 25 of the machine.

The driven machine 8 includes a rotor 11, the shaft 13 of which turns in relation to a stator 15. The shaft 13 carries a fan 18 to circulate the air inside the driven machine 8.

The connection system 10 is arranged between the driven machine 8 and the driving machine 5 inside a space 27 delimited laterally by a tubular connection skirt 29 carried on the housing 25 of the driving machine 5 and attached to a flange 32 of the driven machine.

The connection system 10 includes a driving machine disk 40 attached to the flywheel 23 of the driving machine 5, and a driven machine disk 43 attached to the shaft 13.

The disks 40 and 43 extend generally perpendicular to the axis of rotation X.

The disk 40 is attached to the flywheel 23 by screws 45 arranged around the peripheral portion 68 of the disk.

The diameter of the driving machine disk 40 is preferably greater than the diameter D of the driven machine disk 43 so that the heads of the screws 45 go past the peripheral portion 68 of the driving machine disk and do not prevent the two disks 40 and 43 from being moved towards one another during assembly.

The disk 43 is attached to the shaft 13 by screws 45 arranged close to the axis of rotation X.

The disk 40 has first reliefs 50 and the disk 43 has second reliefs 53 that engage with the first reliefs 50 to ensure torque transmission.

The first reliefs 50 and the second reliefs 53 are preferably equally distributed angularly about the axis of rotation X, as shown in FIGS. 2 and 4.

The number n₁ of first reliefs 50 is preferably equal to the number n₂ of second reliefs, with n₁ and n₂ being preferably within the range 2-20, and ideally within the range 4-12.

The disks 40 and 43 each have an opening 48 at the center of same that is designed to receive and center the extremity of the shaft 13.

In a variant, the disks 40 and 43 each have a centering extension (not shown) enabling the disks 40 and 43 to be correctly positioned in the electricity generator 2.

The disks 40 and 43 have centering reliefs designed to facilitate alignment of the two disks 40 and 43 on the axis of rotation.

As shown in FIG. 2, the disk 40 may have a centering relief 55 designed to receive a centering relief 58 present on the disk 43. The relief 55 may be a recess and the relief 58 may be a boss, or vice versa. The shapes of the centering reliefs 55 and 58 enable a reciprocal rotation of the two disks 40 and 43 at an angle enabling the first and second reliefs 50 and 53 to engage with one another.

As shown in FIG. 1, the centering relief 55 may also be able to accommodate the heads of the screws 45 passing from the side of the disk 43 opposite the driven machine 8.

As shown in FIG. 2, the first reliefs 50 may be hooks that project from the side opposite the driving machine 5 and that are oriented radially towards the axis of rotation X.

These hooks 60 are preferably made by cutting and stamping the driving machine disk 40.

The circumference of the hooks 60 is preferably greater than the radius. The hooks 60 preferably have one circumferential extremity 63 that is open and one circumferential extremity 65 that is closed.

As shown in the cross section in FIG. 3, portions of the driving machine disk 40 may extend in different abscissa planes on the axis of rotation X. The periphery 68 of the disk may extend in an abscissa plane x₁ between the abscissa plane x₂ of the base of the recess 55 and the abscissa x₃ of the contact plane 69 between the two disks 40 and 43.

The contact plane 69 and the recess 55 may be joined by a tapered first portion 40b. The periphery 68 of the disk and the contact plane 69 may be joined by a tapered second portion 40a.

The first reliefs 50 preferably project beyond the abscissa contact plane x₃ by a height h of between 3 mm and 12 mm.

As shown in FIGS. 4 and 5, the second reliefs 53 may be teeth 70 extending radially outwards on the periphery of the disk 43.

The external radial extremity 72 of the teeth 70 is curved towards the side opposite the driven machine 8 to fit the shape of the tapered portion 40a of the disk 40.

During assembly, the disks 40 and 43 are brought into contact at the plane 69 with the first reliefs 50 and the angularly offset second reliefs 53. The disk 40 is then caused to rotate by starting the driving machine 5 so that the first reliefs 50 engage with the corresponding second reliefs 53, as shown in FIG. 6. During reciprocal rotation of the two disks 40 and 43, the teeth 70 engage via the open extremities 63 in the hooks 60 and are locked inside same. The disks 40 and are then rigidly connected and the torque of the driving machine 5 can be transmitted to the driven machine 8.

FIGS. 7 to 10 show variants of the disks 40 and 43 that differ from the disks shown in FIGS. 1 to 6 in particular in the shape and arrangement of the first and second reliefs 50 and 53.

The first reliefs 50 are in this case oriented orthoradially and the radius of same is greater than the circumference of same.

The first reliefs 50 are hooks 83 at least partially closed at the radial extremities 85 of same.

The second reliefs 53 are hooks 88 oriented orthoradially and preferably oriented towards the same side as the hooks 83 when the two disks 40 and 43 are seen from the front.

The hooks 83 and 88 may each be curved at the free extremity 87 and 89 of same towards the outside of the corresponding disk 40 or 43, in order to fit the shape of the corresponding relief on the other disk.

During assembly, the first reliefs 50 come into contact with the surface 93 of the disk 43 facing the side opposite the driven machine and the second reliefs 53 come into contact with the surface 90 of the disk 40 facing the side opposite the driving machine, the first reliefs 50 and the second reliefs 53 being angularly offset. The disk 40 is then caused to rotate and the first reliefs 50 engage with the corresponding second reliefs 53, as shown in FIG. 11.

In this case, the disks 40 and 43 do not have any centering reliefs that fit together.

The disk 40 preferably lies in two mutually parallel planes, the first defining the contact surface 90 with the second reliefs 53 during assembly of the two disks and 43 and the second plane corresponding to the base of the recess 55. The recess 55 receives the heads of the screws attaching the disk 43 to the shaft 13 passing from the side opposite the driven machine 8 to ensure that these latter do not prevent the disks 40 and 43 from coming into contact with one another.

Preferably, as shown in FIGS. 8, 10 and 11, the first reliefs 50 and/or the second reliefs 53 each have an incline around the circumference of same forming an angle a of between 2° and 10° in relation to a plane perpendicular to the axis X. Such an incline helps to join the reliefs 50 and 53 together without any play.

The torque delivered by the driving machine 5 is variable and drives the regular acceleration and deceleration of the disks 40 and 43. The rotational inertia of the rotor of the alternator during deceleration phases tends to cause the disks to separate.

Preferably, the first reliefs 50 and/or the second reliefs 53 have locking reliefs that lock the driven machine disk 43 in relation to the driving machine disk to prevent separation of the two disks 40 and 43 during deceleration phases.

As shown in FIGS. 12 and 13, the locking reliefs may include at least one tab 75 on either the first relief 50 or the second relief 53, and a seat 78 on the other of the first relief 50 or the second relief 53 that is designed to receive this tab 75.

In the example shown in FIGS. 12 to 14, the seat 78 is defined by cutting and stamping the second reliefs 53. The tab 75 is formed by cutting the second relief 53 on the side opposite the side of the free extremity between two grooves 85 formed by cutting, in particular on the second disk 43 before stamping.

The tab 75 is curved towards the outside of the driven machine 8. During assembly, the second relief 53 engages with the first reliefs 50 by penetrating the seat 78. The tab 75 also penetrates the seat 78 and presses against the edge 84 of the first disk 40 facing the first relief 50. Consequently, in the event of inverse rotation, the second reliefs 53 are locked by the tab 75 and cannot disengage from the first reliefs 50. The disks 40 and 43 are not uncoupled. In the variant shown in FIG. 15, the locking reliefs have radially oriented slots or notches 80 on the faces in contact with the first and second reliefs. These notches 80 may, on account of the shape thereof, be crossed by notches in the opposite relief during assembly of the disk. Conversely, the teeth formed by these notches tend to oppose the inverse movement.

The invention is not limited to the examples described above, and in particular is not limited to a specific means of centering the disks.

The first and second reliefs may be of any other shape enabling the engagement of same, for example portions of arcs of circles not concentric to the axis of rotation.

The locking reliefs may be different to the locking reliefs described, for example the locking reliefs may be projections arranged on one of the disks that are seated in the recesses formed on the other disk.

1-15. (canceled)

16. A system for coupling a driving machine, with a driven machine, comprising:
a driving machine disk that is configured to be centered on and attached to same along an axis of rotation and that includes first reliefs distributed angularly about the axis of rotation, and
a driven machine disk that is configured to be centered on and attached to same along the axis of rotation and that includes second reliefs distributed angularly about the axis of rotation,
the second reliefs being arranged in relation to the first reliefs such as to enable the coupling system to adopt:
a first arrangement enabling an axial separation along the axis of rotation of the two disks of the driving and driven machines and in which the two disks are in contact, the first reliefs being angularly offset in relation to the second reliefs, and
a second arrangement for transmitting torque, in which the second reliefs engage with the first reliefs and oppose the axial movement of the two disks relative to one another, the shift from the first to the second arrangement being made by a reciprocal rotation of the two disks about the axis of rotation.

17. The coupling system as claimed in claim 16, the first reliefs being obtained by cutting and/or stamping the driving machine disk and/or in that the second reliefs are obtained by cutting and/or stamping the driven machine disk.

18. The coupling system as claimed in claim 16, the second reliefs being hooks projecting from the side of the disk opposite the driven machine or teeth extending radially outwards.

19. The coupling system as claimed in claim 16, the first reliefs being hooks projecting from the side of the disk opposite the driving machine.

20. The coupling system as claimed in claim 19, the hooks being oriented radially inwards.

21. The coupling system as claimed in claim 20, the hooks opening at one of the circumferential extremities of same and closed at the opposite extremity of same.

22. The coupling system as claimed in claim 19, the hooks being oriented orthoradially.

23. The coupling system as claimed in claim 16, the first and/or second reliefs having locking reliefs tending to oppose reciprocal rotation of the disks in the uncoupling direction of the first and second reliefs.

24. The coupling system as claimed in claim 23, the locking relief or reliefs including slots or notches.

25. The coupling system as claimed in claim 23, the locking relief or reliefs present on either the first or second relief including a tab and the locking relief or reliefs present on the other of the first or second reliefs including a seat configured to receive the tab.

26. The coupling system as claimed in claim 25, the tab being cut out from either the first or second relief and engages, when the two disks are assembled, in the cutout defining the other of the first or second relief to lock against the edge of the cutout.

27. The coupling system as claimed in claim 16, the first and second reliefs each having a body with an internal face configured to come into contact with an internal face of the body of the other corresponding relief.

28. The coupling system as claimed in claim 27, the first and second reliefs each having an incline increasing around the circumference forming an angle a of between 2° and 10° with the midplane of the disk.

29. The coupling system as claimed in claim 16, the two disks each having an opening configured to receive and center the shaft of the driven machine and/or a centering relief for at least one of the two disks to align the two disks on the axis of rotation when same are being brought together.

30. The coupling system as claimed in claim 16, the two disks having centering reliefs, the centering reliefs comprising on one of the disks, as seen from the front, at least one recess and on the other disk, as seen from the front, at least one projection that fits into the recess.

31. An electricity generator including:
an engine,
an alternator including a rotor driven in rotation by the engine,
a system for coupling the engine with the alternator as defined in claim 16, transmitting torque between the engine and the alternator, the driving machine disk being attached to the engine, and the driven machine disk being attached to the rotor of the alternator.

32. A method for assembling an electricity generator as claimed in claim 31, including the following steps:
attaching the driving machine disk to a flywheel of the engine,
attaching the driven machine disk to the rotor of the alternator,
moving the two disks towards one another axially to create the first arrangement of the coupling system, and
starting the engine so that the second reliefs engage by reciprocal rotation of the two disks with the first relief in the second arrangement of the coupling system.

33. The coupling system as claimed in claim 16, the driving machine being a thermal engine and the driven machine being an alternator.
